(19) United States
(12) Patent Application Publication
(10) Pub. No.: US 2004/0001085 A1
(43) Pub. Date: Jan. 1, 2004

(54) Data reproduction apparatus and data reproduction method with image display

(75) Inventor: Masao Iwasaki, Fuchu-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/391,543

(22) Filed: Mar. 19, 2003

(30) Foreign Application Priority Data
Mar. 19, 2002 (JP) 2002-076938

(51) Int. Cl. G09G 5/00

(52) U.S. Cl. 345/738

(57) ABSTRACT

A data reproduction apparatus includes a control section which has a reproduction function of executing decoding processing for acquired content information with image information to output a reproduction signal, a display section which displays information corresponding to the content information or operation information, and an image switch which is provided on the apparatus main body to display the image information. The control section has a function of executing control so as to detect that the image switch is operated and display an image corresponding to the image information on the display section. Only by pressing the image switch, for example, the jacket image for a music source can immediately be displayed on the display section.

### CROSS-REFERENCE TO RELATED APPLICATIONS

This application is based upon and claims the benefit of priority from the prior Japanese Patent Application No. 2002-076938, filed Mar. 19, 2002, the entire contents of which are incorporated herein by reference.

### BACKGROUND OF THE INVENTION

1. Field of the Invention

The present invention relates to a data reproduction apparatus and, more particularly, to a data reproduction apparatus and data reproduction method which reproduces audio-related information and simultaneously displays corresponding image information.

2. Description of the Related Art

Along with recent progresses in the digital technology, portable digital audio reproduction apparatuses in which music reproduction apparatuses also handle audio information as digital information have been developed and become popular.

A reference about such a digital audio reproduction apparatus is Jpn. Pat. Appln. KOKAI Publication No. 2001-155466. This reference discloses a technique for a digital audio reproduction apparatus which automatically selectively displays a jacket image, a lyric text, or the like as a music is reproduced.

In this conventional digital audio reproduction apparatus, however, an image or a text is displayed on the display section independently of user's wish. The apparatus has no operation switch which immediately reflects user's intention to, e.g., see a jacket image for a music. That is, to display a jacket image for a music on the liquid crystal display to see the image, the user must wait until the jacket image is automatically displayed as the music is reproduced. Alternatively, a specific image such as a jacket image can be displayed at an arbitrary timing only by causing the user to invoke a menu window by operating buttons, search for the image display operation window in accordance with the directory structure, and invoke the jacket window onto the operation window. This operation is very cumbersome.

### BRIEF SUMMARY OF THE INVENTION

It is an embodiment of the present invention to provide a data reproduction apparatus which makes it possible to instantaneously easily display a desired image by preparing a switch for image display on the main body of the data reproduction apparatus.

According to an aspect of the present invention, there is provided a data reproduction apparatus comprising an interface which acquires content information with image information by reading out the content information from an information storage medium loaded to the interface or receiving the content information from an external device, a reproduction section which reproduces the content information acquired via the interface by executing decoding processing for the content information and outputs a reproduction signal, a display section which displays at least one of predetermined information corresponding to the content information that is being reproduced by the reproduction section and user operation information, an image switch which is provided on a main body of the data reproduction apparatus to display the image information acquired via the interface, and a control section which executes control so as to detect that the image switch is operated and display an image corresponding to the image information on the display section.

As described above, the present invention is a data reproduction apparatus which makes it possible to quickly and easily display a specific image such as a jacket image for a music source, which the user wants frequently to display, only by pressing a dedicated switch. Hence, there is provided a data reproduction apparatus which can display an image with an excellent operability without any cumbersome operation for invoking a menu window, displaying an image display operation window in accordance with the directory structure of the menu, specifying the image, and then displaying the desired image, unlike a conventional apparatus.

### BRIEF DESCRIPTION OF THE SEVERAL VIEWS OF THE DRAWING

FIG. 1 is a block diagram showing the arrangement of a data reproduction apparatus according to an embodiment of the present invention;

FIG. 2 is a view showing the external appearance of the data reproduction apparatus according to the present invention;

FIGS. 3A, 3B, and 3C are views showing examples of a display window displayed in the data reproduction apparatus according to the embodiment of the present invention; and

FIG. 4 is a flow chart for explaining image display processing in the data reproduction apparatus according to the embodiment of the present invention.

### DETAILED DESCRIPTION OF THE INVENTION

A data reproduction apparatus according to the present invention will be described below in detail with reference to the accompanying drawing.

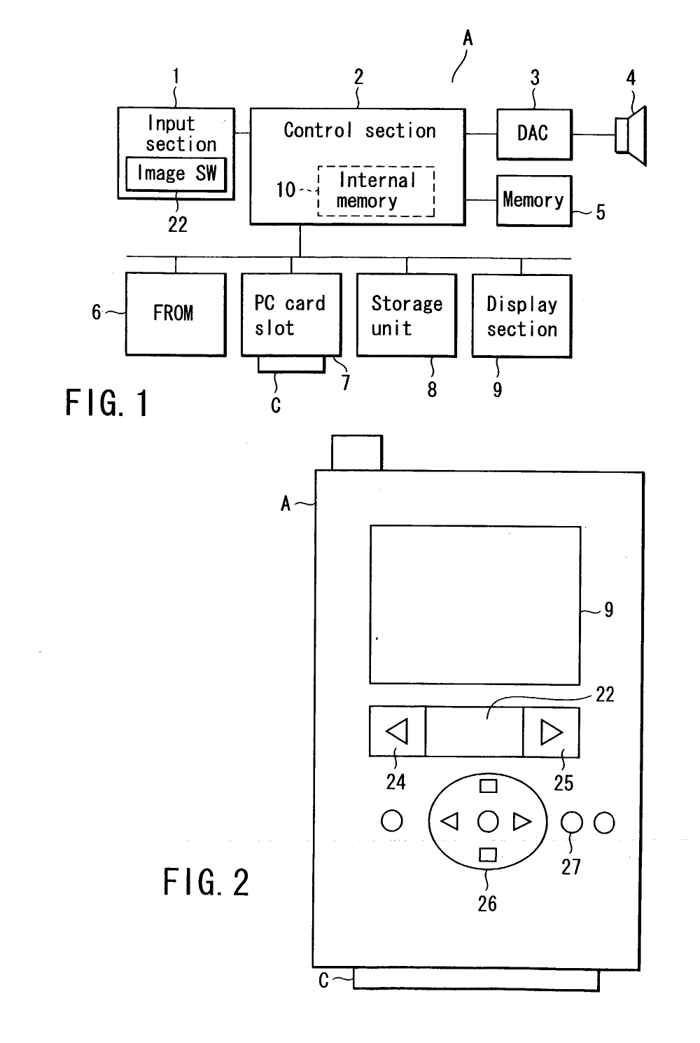

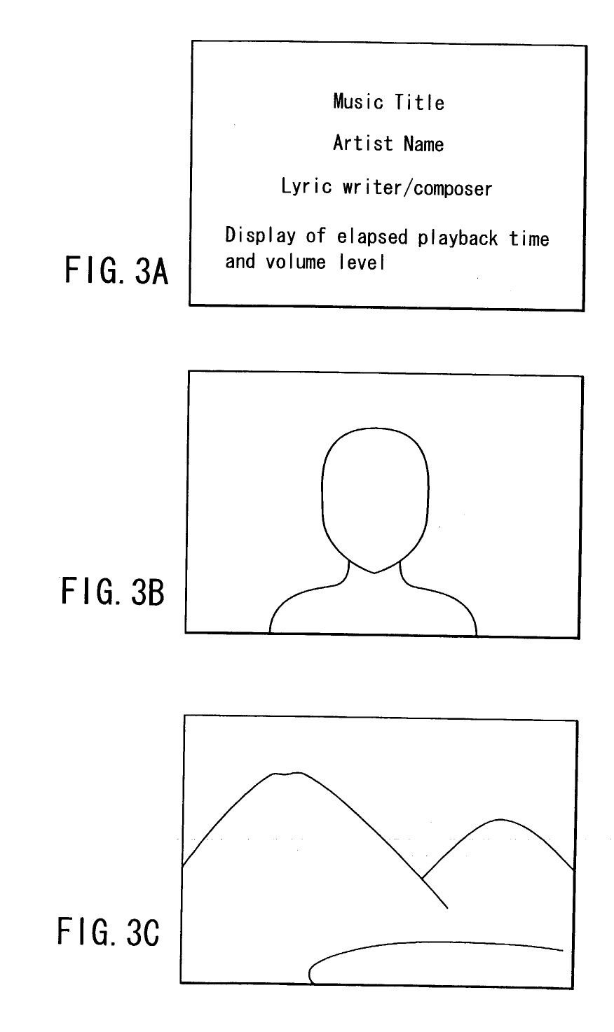

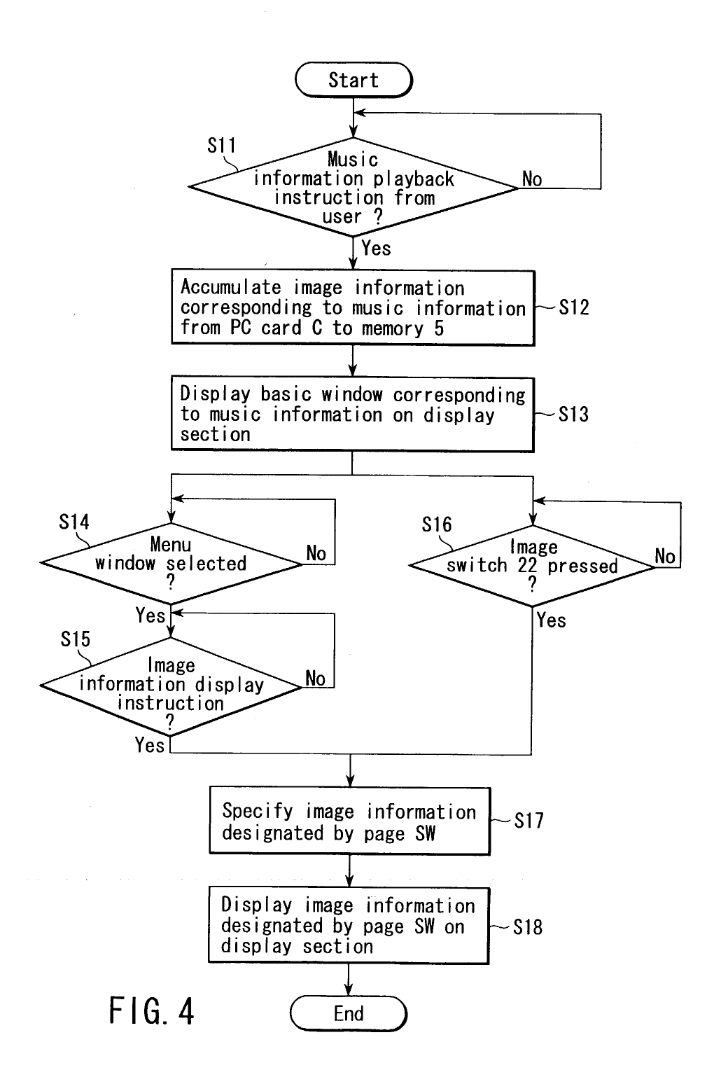

FIG. 1 is a block diagram showing the arrangement of a data reproduction apparatus according to an embodiment of the present invention. FIG. 2 is a view showing the external appearance of the data reproduction apparatus. FIGS. 3A, 3B, and 3C are views showing examples of a display window displayed in the data reproduction apparatus according to the present invention. FIG. 4 is a flow chart for explaining image display processing according to the present invention.

As an example of the data reproduction apparatus of the present invention, a music reproduction apparatus which handles digital audio information will be described below. However, the present invention is not limited to this. Any other data reproduction apparatus which widely handles general content information and has a function of displaying specific image information on the apparatus can exhibit the same functions and effects within the spirit and scope of the present invention.

<Structure of Data Reproduction Apparatus>

Referring to FIG. 1, a data reproduction apparatus A has an input section 1 with an image switch 22 as a characteristic feature of the present invention. The input section 1 is an input element like a jog dial 26 and press buttons 27, with which a user can do key operation to operate the data reproduction apparatus, as shown in FIG. 2. For example, page switches 24 and 25 for sequentially displaying a plurality of images and the like are laid out on both sides of the image switch 22. The data reproduction apparatus A also has a control section 2 having a function of controlling each section of the data reproduction apparatus and decoding supplied content information such as audio-related information. The control section 2 has an internal memory 10. For example, an SRAM (Static Random Access Memory) with a high processing speed is used. Hence, image information or the like can quickly be displayed on a display section 9, as will be described later.

In the data reproduction apparatus A, a D/A (Digital/Analog) converter 3 which receives a reproduction signal as a decoded digital signal and converts it into an analog signal is connected to the control section 2. The output from the D/A converter 3 is supplied to a loudspeaker 4 or an output terminal (not shown). The section formed from the control section 2 and D/A converter 3 will be referred to as a reproduction section. The reproduction signal as a digital signal may be output from an output terminal. In addition, a memory 5 made of, e.g., an SDRAM (Synchronous Dynamic Random Access Memory) is connected to the control section 2. The memory 5 stores and executes a program that operates the data reproduction apparatus and is used as a work memory for the program.

An FROM (Flash Read Only Memory) 6 is connected through a data bus. For example, a program that operates the data reproduction apparatus is stored in the FROM 6. Alternatively, parameter values such as user set values are recorded in the FROM 6. A PC (Personal Computer) card adapter 7 is also connected to the data bus. An ATA (AT Attachment) card C of general PC card type is attached to the PC card adapter 7 so that stored content information such as audio information or image information is read out.

A recording unit 8 such as a hard disk is also connected to the data bus. For example, audio-related information to be reproduced by the data reproduction apparatus is recorded. The audio-related information recorded on the ATA card C connected to the PC card adapter 7 or in the recording section 8 is compressed information such as a PCM (Pulse Code Modulation) format, WMA, or MPEG3 (Moving Picture Experts Group 3).

The display section 9 such as a liquid crystal display is also connected to the data bus to display, for the user, the current system state or the like, as will be described later.

<Operation and Characteristic Feature of Data Reproduction Apparatus>

A procedure for causing the data reproduction apparatus to reproduce audio-related information such as a music will be described next in detail with reference to the flow chart shown in FIG. 4.

(Reproduction of Audio Information or the Like)

In a power-off state, the user presses the power switch 27 of the input section 1. Then, the program stored in the FROM 6 is transferred to the memory 5 and executed. The system is activated, and the current state is displayed on the display section 9.

The user selects music information to be reproduced using the operation keys such as the jog dial 26 of the input section 1 while observing the display section 9. At this time, a list of music information stored in the recording device such as the recording unit 8 or the ATA card C connected to the PC card adapter 7 is generated and displayed on the display section 9. The above-described processing is executed under the control of the control section 2.

When the user selects music information, the control section 2 transfers the selected music information from the ATA card C connected to the PC card adapter 7 or the recording unit 8 to the memory 5. If the audio-related information has been compressed, the compressed informant is expanded using the control section 2 and memory 5, and the result is transferred to the D/A converter 3.

The D/A converter 3 converts the digital signal transferred from the control section 2 into analog information. Accordingly, a sound is reproduced from the loudspeaker 4. At this time, the display section 9 displays, e.g., the music title, the artist name, the lyric writer/composer, or the elapsed reproduction time and volume level corresponding to the audio-related information, as shown in FIG. 3A.

(Image Display)

Image display on the display section 9 will be described. If a music data reproduction instruction is input by the user in accordance with the above-described procedure (S11), image information corresponding to the music-related information is accumulated from the PC card C into the memory 5 (S12). While music information or the like is being reproduced as audio-related information, the music title, the artist name, the lyric writer/composer, or the elapsed reproduction time and volume level, shown in FIG. 3A, are displayed as a basic window, as described above (S13).

When the user wants to see the jacket image for the music information, a lyric card prepared as image information, or a photographic image of the singer during reproduction of the music, he/she can see the image in accordance with the following procedure.

As a general method, the jog dial 26 and the like are operated to invoke a menu window in the system (S14). An image display operation window is searched for in accordance with the directory structure, and the jacket window is displayed on this window (S15). With this operation, a specific image such as a jacket image can be displayed at an arbitrary timing. However, this operation is very cumbersome.

When the image switch 22 shown in FIG. 2 is pressed, the control section 2 detects this operation (S16). If there are a plurality of images, as shown in FIGS. 3B and 3C, the image indicated by the page switch 24 or 25 is determined by the control section 2 (S17). The pieces of image information are recorded on the ATA card C attached to the PC card adapter 7 serving as an interface or in the recording unit 8. The designated image information is transferred from the adapter 7 or recording unit 8 to the control section 2. If the image has been compressed, it is expanded and displayed on the display section 9 under the control of the control section 2 (S18).

To display an image, a method of reading out image information from the ATA card C in accordance with an image display instruction from the user or a method of reading out image information in advance together with audio-related information, transferring the image information to the memory 5, and temporarily storing it can be used. The latter method makes smoother operation possible. More specifically, when the user wants to see image information and executes menu operation or presses the image switch 22, the image information that is temporarily stored in the memory 5 is transferred to the display section 9. Hence, the image corresponding to the image information can quickly be displayed.

To return the display to the initial basic window (FIG. 3A), the control section 2 determines it by detecting that the image switch 22 is pressed again or that a switch prepared to display the basic window is pressed. Then, normal display data prepared in the memory 5 is transferred to the display section 9 so that the display can be switched.

It is appropriate to prepare the image switch 22 to invoke only a specific image such as a jacket image. The image switch 22 can be set by an operation program to immediately display a specific image by pressing the image switch 22 once. In addition, which image should correspond to the image switch 22 can be set on the menu window or the like.

As a modification of the present invention, it is also preferable that the image switch 22 have another function by, e.g., changing the mode instead of making only a specific image correspond to the image switch 22. In addition, a specific image need not always be displayed by pressing the image switch 22 once. Instead, as another modification of the present invention, it is also preferable that the image switch 22 function as a switch capable of more easily invoking a specific image than the menu window.

The above-described page switches 24 and 25 are particularly effective when the number of specific images increases to, e.g., 5 or 10. When the page switches 24 and 25 are operated, the user can continuously select desired images. The operation section 2 selects one of the plurality of specific images corresponding to the number of pages specified by the page switches 24 and 25 and transfers the selected image to the display section 9. Accordingly, the user can freely cause the display section 9 to display a desired one of the plurality of images.

(Use of Cache Memory)

A specific image is preferably read out simultaneously when audio-related information such as music information is read out from the ATA card C or the like, subjected to expansion processing as needed, and stored in advance in the internal memory 10 such as an SRAM incorporated in the control section 2. At this time, in accordance with a display instruction from the image switch 22 or the like, the specific image can quickly be transferred to the display section 9 and displayed using the high transfer speed between the control section 2 and the internal memory 10.

As described above, when the image switch 22 dedicated to instruct image display is prepared, the user can easily and quickly cause the display section to display a specific image such as a jacket image or lyric card.

<Form of Image Display Switch>

The functions and effects of the present invention can be obtained even when the image switch 22 takes various forms other than the above-described form. For example, the switch used to display a specific image is preferably a panel switch provided on the display section 9 formed from a liquid crystal screen. In this case, the control section 2 detects that the user has touched the panel switch so that the specific image can immediately be displayed on the display section 9.

The image display switch may be prepared in remote control switches integrated with, e.g., headphones (not shown) as the output of the data reproduction apparatus. In this case, image display can be instructed, like volume level setting or selection of music. Switches in many other forms can also be applied to the present invention, and the same functions and effects can be obtained within the spirit and scope of the present invention.

Those skilled in the art can implement the present invention by the above-described various embodiments. It is easy for those skilled in the art to make various changes and modifications of the embodiments. It is easy to apply the invention to various embodiments without any inventive capability. The present invention is therefore constructed broadly within the spirit and scope that are not inconsistent with its disclosed principle and new features and is not limited to the above-described embodiments.

In the data reproduction apparatus according to the present invention, while audio-related information is being reproduced, information such as the reproduction time or artist name is displayed on the display section. When the user operates the image switch, an image such as a jacket image or lyric card related to the music source that is being reproduced is instantaneously displayed. Accordingly, the jacket image or lyric card whose display is expected to be frequently wanted can very easily be displayed.

In addition, image information to be displayed is expanded and stored in the cache memory of the control section in advance. When the image display key is pressed, the image information can quickly be displayed by transferring the data in the memory to the display section.

What is claimed is:

1. A data reproduction apparatus comprising:
an interface which acquires content information with image information by reading out the content information from an information storage medium loaded to the interface or receiving the content information from an external device;
a reproduction section which reproduces the content information acquired via the interface by executing decoding processing for the content information and outputs a reproduction signal;
a display section which displays at least one of predetermined information corresponding to the content information that is being reproduced by the reproduction section and user operation information;
an image switch which is provided on a main body of the data reproduction apparatus and displays the image information acquired via the interface; and
a control section which executes control so as to detect that the image switch is operated and display an image corresponding to the image information on the display section.

2. An apparatus according to claim 1, wherein
the image switch is provided exclusively to display the image information acquired via the interface, and
the control section executes control so as to display the image corresponding to the image information on the display section by only detecting that the image switch is pressed once.

3. An apparatus according to claim 1, wherein the control section executes control so as to display at least one of the predetermined information corresponding to the content information and the user operation information while the reproduction section is reproducing the content information and, upon detecting that the image switch is operated, so as to switch the display to the image corresponding to the image information.

4. An apparatus according to claim 1, further comprising:
a page switch provided on the main body of the data reproduction apparatus, and
in which the control section executes control so as to detect that the page switch is operated and, when the image information contains a plurality of pieces of image information, sequentially display images corresponding to the plurality of pieces of image information on the display section.

5. An apparatus according to claim 1, wherein
the image switch is a panel switch provided on a surface of the display section, and
the control section executes control so as to display the image corresponding to the image information on the display section by detecting that the user touches the panel switch.

6. An apparatus according to claim 1, further comprising:
a remote control unit which gives an operation signal to the control section, and
a page switch which is arranged on the remote control unit to display the image information acquired via the interface, and
in which the control section executes control so as to display the image corresponding to the image information on the display section by detecting that the page switch is operated.

7. An apparatus according to claim 1, further comprising:
an expansion control section which expands in advance the image information acquired via the interface, and
a memory which stores in a storage area the image information expanded by the expansion control section, and
in which the control section executes control so as to detect that the image switch is operated, read out the expanded image information stored in the memory, and display the image corresponding to the image information on the display section.

8. A data reproduction apparatus comprising:
acquisition means, to which an information storage medium is loaded, for acquiring content information with image information by reading out the content information from an information storage medium or receiving the content information from an external device;
reproduction means for reproducing the content information acquired by the acquisition means by executing decoding processing for the content information and outputting a reproduction signal;
display means for displaying at least one of predetermined information corresponding to the content information that is being reproduced by the reproduction means and user operation information;
image switch means, provided on a main body of the data reproduction apparatus, for displaying the image information acquired by the acquisition means; and
control means for executing control so as to detect that the image switch means is operated and display an image corresponding to the image information on the display means.

9. An apparatus according to claim 8, wherein
the image switch means is provided exclusively to display the image information acquired by the acquisition means, and
the control means executes control so as to display the image corresponding to the image information on the display means by only detecting that the image switch means is pressed once.

10. An apparatus according to claim 8, wherein the control means displays on the display means at least one of the predetermined information corresponding to the content information and the user operation information while the reproduction means is reproducing the content information and, upon detecting that the image switch means is operated, executes control so as to switch the display to the image corresponding to the image information.

11. An apparatus according to claim 8, further comprising:
second image switch means provided on the main body of the data reproduction apparatus, and
in which the control means executes control so as to detect that the second image switch means is operated and, when the image information contains a plurality of pieces of image information, sequentially display images corresponding to the plurality of pieces of image information on the display means.

12. An apparatus according to claim 8, wherein
the image switch means is a panel switch provided on a surface of the display means, and
the control means executes control so as to display the image corresponding to the image information on the display means by detecting that the user touches the panel switch.

13. An apparatus according to claim 8, further comprising:
a remote control unit which gives an operation signal to the control means, and
second image switch means, arranged on the remote control unit, for displaying the image information acquired by the acquisition means, and
in which the control means executes control so as to display the image corresponding to the image information on the display means by detecting that the second image switch means is operated.

14. An apparatus according to claim 8, further comprising:
expansion means for expanding in advance the image information acquired by the acquisition means, and
storage means for storing in a storage area the image information expanded by the expansion means, and
in which the control means executes control so as to detect that the image switch means is operated, read out the expanded image information stored in the storage means, and display the image corresponding to the image information on the display means.

15. A data reproduction method comprising:
acquiring content information with image information by reading out the content information from an information storage medium connected to a data reproduction apparatus or receiving the content information from an external device;
reproducing and outputting the acquired content information by executing decoding processing for the content information; and
executing control so as to detect that an image switch is operated and display an image corresponding to the image information on a display section, the image switch being provided on a main body of the data reproduction apparatus to display the acquired image information.

16. A method according to claim 15, wherein
the image switch is provided exclusively to display the image information acquired via the interface, and
the executing control so as to display the image corresponding to the image information on the display section by only detecting that the image switch is pressed once.

17. A method according to claim 15, wherein the executing control to display at least one of the predetermined information corresponding to the content information and the user operation information while the content information is being reproduced and, upon detecting that the image switch is operated, so as to switch the display to the image corresponding to the image information.

18. A method according to claim 15, wherein the controlling executes control so as to detect that a page switch provided on the main body of the data reproduction apparatus is operated, and when the image information contains a plurality of pieces of image information, sequentially display images corresponding to the plurality of pieces of image information on the display section.

19. A method according to claim 15, wherein
the image switch is a panel switch provided on a surface of the display section, and
the control section executes control so as to display the image corresponding to the image information on the display section by detecting that the user touches the panel switch.

20. A method according to claim 15, wherein
the controlling executes control so as to display the image corresponding to the image information on the display section by detecting, using a remote control unit having a page switch to display the image information acquired via the interface, that the page switch is operated.
